(19) United States
(12) Patent Application Publication
(10) Pub. No.: US 2026/0066185 A1
(43) Pub. Date: Mar. 5, 2026

(54) COIL DEVICE

(71) Applicant: TDK Corporation, Tokyo (JP)

(72) Inventors: Toshiyuki HORIKAWA, Tokyo (JP); Masayuki Nagata, Tokyo (JP); Kiho Hwang, Tokyo (JP); Myungsung Kim, Tokyo (JP)

(73) Assignee: TDK Corporation, Tokyo (JP)

(21) Appl. No.: 19/302,444

(22) Filed: Aug. 18, 2025

(30) Foreign Application Priority Data
Aug. 30, 2024 (JP) 2024-150261

(51) Int. Cl. H01F 27/30; H01F 27/28

(52) U.S. Cl. CPC H01F 27/306; H01F 27/2847

(57) ABSTRACT

A coil device includes a flat wire including a coil portion and a lead-out portion drawn out from the coil portion; a core disposed around the coil portion; and a case including a housing portion housing the coil portion along a housing direction perpendicular to a winding axis direction of the coil portion, a core supporting portion connected to one end of the housing portion in the housing direction and supporting the core, and a coil supporting portion supporting an outer circumferential surface of the coil portion. The housing portion covers at least a part of the outer circumferential surface of the coil portion.

The present application claims a priority to Japanese patent application No. 2024-150261 filed on Aug. 30, 2024, which is incorporated herein by reference in its entirety.

### BACKGROUND

The present disclosure relates to a coil device.

Disclosed in, for example, Patent Document 1 is a coil device including a flat coil and a core disposed around the coil. A main leg portion of the core is inserted in the coil. The coil is thus attached to the core. For including the flat coil, the coil device of Patent Document 1 can be reduced in size and be thinned.
Patent Document 1: JP Patent Application Laid Open No. 2013-131589

### SUMMARY

A coil device according to one aspect of the present disclosure includes:
a flat wire including a coil portion and a lead-out portion drawn out from the coil portion;
a core disposed around the coil portion; and
a case including
a housing portion housing the coil portion along a housing direction perpendicular to a winding axis direction of the coil portion,
a core supporting portion connected to one end of the housing portion in the housing direction and supporting the core, and
a coil supporting portion supporting an outer circumferential surface of the coil portion, wherein the housing portion covers at least a part of the outer circumferential surface of the coil portion.

### BRIEF DESCRIPTION OF THE DRAWING(S)

FIG. 1 is a perspective view of a coil device of a first embodiment.

FIG. 2 is an exploded perspective view of the coil device shown in FIG. 1.

FIG. 3 is a perspective view of a case shown in FIG. 2.

FIG. 4 is a plan view of the coil device shown in FIG. 1.

FIG. 5 is a sectional view along a line V-V shown in FIG. 1.

FIG. 6 is a sectional view along a line VI-VI shown in FIG. 1.

FIG. 7 is a perspective view of a coil device of a second embodiment.

FIG. 8 is an exploded perspective view of the coil device shown in FIG. 7.

FIG. 9 is a perspective view of the coil device shown in FIG. 7 with cores being omitted.

FIG. 10 is a perspective view of a case shown in FIG. 8.

FIG. 11 is a sectional view along a line XI-XI shown in FIG. 7.

### DETAILED DESCRIPTION

Hereinafter, embodiments of the present disclosure are described with reference to the drawings. Illustrations in the drawings are only schematically and exemplarily provided for understanding of the present disclosure; and the illustrated appearance, dimensional ratios, and the like may be different from actual ones. The present disclosure is not limited to the following embodiments.

### First Embodiment

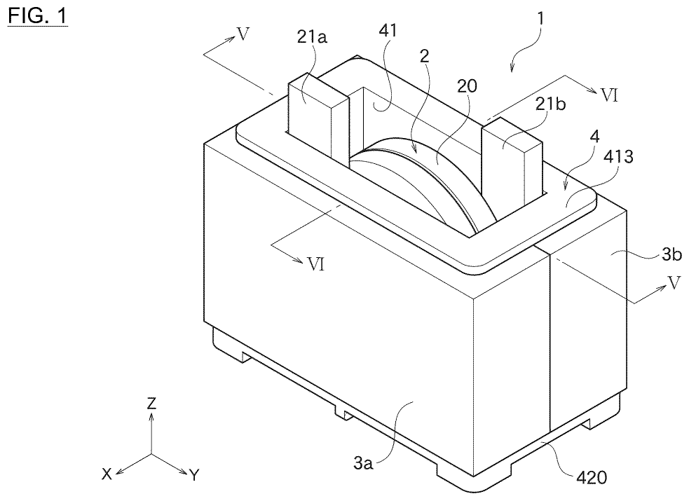

A coil device 1 of a first embodiment shown in FIG. 1 functions as, for example, an inductor and is mounted on a power supply circuit or the like of electronic equipment. The coil device 1 includes at least a wire 2, cores 3a to 3b, and a case 4.

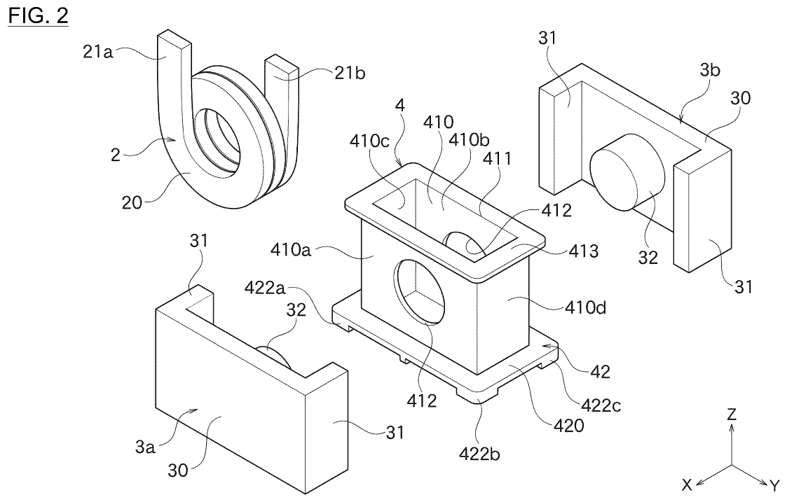

As shown in FIG. 2, the wire 2 includes a coil portion 20 and lead-out portions 21a to 21b drawn out from the coil portion 20. The coil portion 20 is an air core coil and is provided by helically winding the wire 2. The wire 2 is a wire having a flat shape. It is an edgewise wound rectangular wire. However, the wire 2 may be a flatwise wound rectangular wire. The lead-out portion 21a is one end of the wire 2 whereas the lead-out portion 21b is the other end of the wire 2.

The wire 2 is, for example, an insulation-coated wire. The wire 2 is a known wire, such as a polyamide-imide copper wire (AIW), a polyurethane copper wire (UEW), or a polyester copper wire (PEW). The wire 2 is a rectangular wire but may be a square wire, a round wire, a stranded wire, a litz wire, a braided wire, or the like. A core wire of the wire 2 may be made from any material. Examples of such materials include copper, a copper alloy, silver, and nickel. The wire 2 may have any thickness (length between one main surface and the other main surface of the wire 2). The thickness is, for example, 20 μm to 200 μm. The wire 2 may have any width. The width is, for example, 40 μm to 400 μm.

The cores 3a and 3b are made from a material including a magnetic material and a resin. The cores 3a and 3b may include any magnetic material. Examples of such magnetic materials include ferrites (e.g., Ni—Zn based ferrites and Mn—Zn based ferrites) and metal magnetic bodies (e.g., Fe—Ni alloys, Fe—Si alloys, Fe—Si—Cr alloys, Fe—Co alloys, Fe—Si—Al alloys, and amorphous iron). The cores 3a and 3b may include any resin. Examples of such resins include an epoxy resin, a phenol resin, a polyester resin, a polyurethane resin, and a polyimide resin. The cores 3a and 3b may be sintered bodies of a metal magnetic body.

The cores 3a and 3b are each an E-shaped core and are disposed around the coil portion 20. The cores 3a and 3b have the same shape but may have different shapes. The cores 3a and 3b each include a base portion 30, a pair of outer leg portions 31, and a middle leg portion 32.

Hereinafter, an axis along a direction in which the cores 3a and 3b face each other is referred to as an X-axis. An axis along a direction in which the outer leg portions 31 face each other is referred to as a Y-axis. An axis perpendicular to the X-axis and the Y-axis is a Z-axis. The X-axis corresponds to the winding axis direction of the coil portion 20. The X-axis, the Y-axis, and the Z-axis are mutually perpendicular.

In the present disclosure, a positive direction of the Z-axis is referred to as an upward direction, whereas a negative direction of the Z-axis is referred to as a downward direction. However, the upward direction of the Z-axis does not necessarily match a vertically upward direction. Likewise, the downward direction of the Z-axis does not necessarily match a vertically downward direction.

The outer leg portions 31 are located at both ends of the base portion 30 in the Y-axis direction and protrude from the base portion 30. The middle leg portion 32 is located between the outer leg portions 31 and protrudes from the base portion 30. Protruding directions of the outer leg portions 31 and the middle leg portion 32 are not limited. The outer leg portions 31 and the middle leg portion 32 protrude in a direction perpendicular to the base portion 30.

In the present disclosure, “perpendicular” is not a concept indicating only a strictly perpendicular state; and the concept of “perpendicular” includes a state with a variation of ±Δθ° or less (not limited; e.g., Δθ=3) with respect to the strictly perpendicular state. Likewise, “parallel” is not a concept indicating only a strictly parallel state; and the concept of “parallel” includes a state with a variation of ±Δθ° or less (not limited; e.g., Δθ=3) with respect to the strictly parallel state.

The outer leg portions 31 have a rectangular cross-sectional shape (in a section perpendicular to the X-axis); however, the cross-sectional shape may be a square shape, other polygonal shape, a circular shape, an oval shape, or other shape. The middle leg portion 32 has a circular cross-sectional shape; however, the cross-sectional shape may be an oval shape, a square shape, a rectangular shape, other polygonal shape, or other shape.

Either the core 3a or the core 3b may be an E-shaped core, and the other may be an I-shaped core. The cores 3a and 3b may each be composed of multiple cores. The core 3a may be composed of, for example, multiple I-shaped cores combined in an E shape. Alternatively, the core 3a may be composed of a U-shaped core and an I-shaped core combined in an E shape. The same applies to the core 3b.

With the cores 3a and 3b being attached to the case 4, extremities of the outer leg portions 31 of the core 3a are in contact with extremities of the outer leg portions 31 of the core 3b. However, between the extremities of the outer leg portions 31 of the core 3a and the outer leg portions 31 of the core 3b may be gaps. With the cores 3a and 3b being attached to the case 4, between an extremity of the middle leg portion 32 of the core 3a and an extremity of the middle leg portion 32 of the core 3b is a gap. However, the extremity of the middle leg portion 32 of the core 3a may be in contact with the extremity of the middle leg portion 32 of the core 3b.

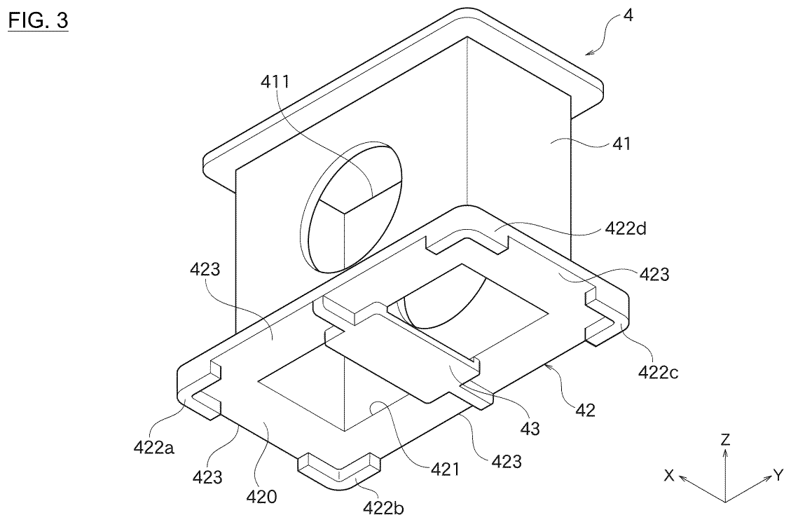

The case 4 is composed of, for example, plastics (e.g., PPS, PET, PBT, and LCP) or other insulating member. The case 4 includes a housing portion 41, a core supporting portion 42, and a coil supporting portion 43 (FIG. 3). In the housing portion 41, the coil portion 20 is housed along a direction (Z-axis direction) perpendicular to the winding axis direction (X-axis direction) of the coil portion 20. Hereinafter, the direction (Z-axis direction) in which the coil portion 20 is housed (inserted) in the housing portion 41 may be referred to as a housing direction.

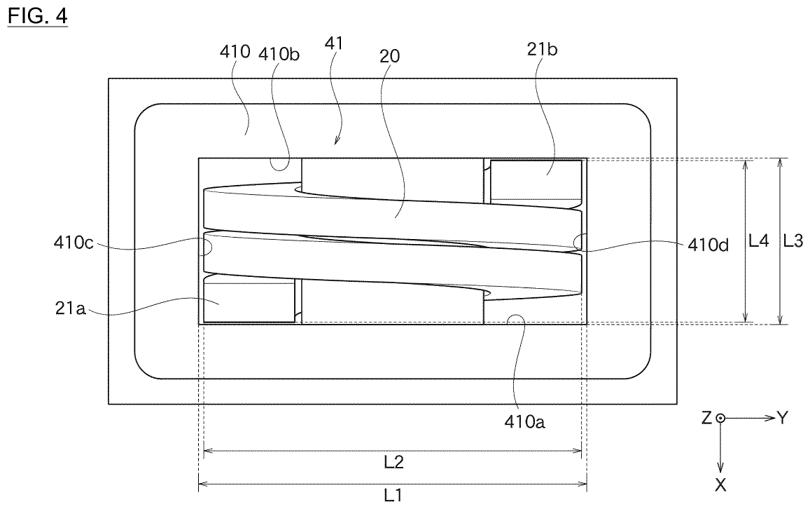

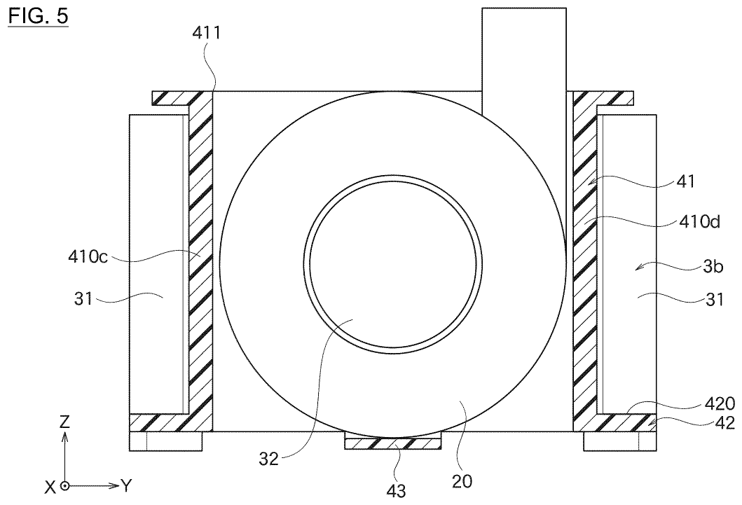

As shown in FIGS. 4 and 5, the housing portion 41 covers at least a part of an outer circumferential surface of the coil portion 20. As shown in FIG. 2, the housing portion 41 includes or has a wall 410, a housing opening 411, communicating paths 412, and a flange 413. The wall 410 has a tubular shape. The wall 410 has a rectangular cross-sectional shape (in a section perpendicular to the Z-axis); however, the cross-sectional shape may be a square shape, other polygonal shape, a circular shape, an oval shape, or other shape. Inside the wall 410, the coil portion 20 can be housed (inserted).

The wall 410 includes a first portion 410a, a second portion 410b, a third portion 410c, and a fourth portion 410d. The first portion 410a and the second portion 410b face each other in the X-axis direction. The third portion 410c and the fourth portion 410d face each other in the Y-axis direction. As shown in FIGS. 4 and 5, the third portion 410c and the fourth portion 410d of the wall 410 at least partly cover the outer circumferential surface of the coil portion 20 from the direction (Y-axis direction) perpendicular to the winding axis direction of the coil portion 20.

As shown in FIG. 2, the housing opening 411 is an opening for housing (inserting) the coil portion 20 in the housing portion 41 and is located at an upper end of the wall 410. Each of the communicating paths 412 is a path for inserting at least a part of the core 3a or 3b (in the present embodiment, the middle leg portion 32) in the housing portion 41 along the winding axis direction of the coil portion 20. The wall 410 has the multiple (in the present embodiment, two) communicating paths 412 each having a hole shape. One communicating path 412 penetrates the first portion 410a of the wall 410 along the winding axis direction of the coil portion 20. The other communicating path 412 penetrates the second portion 410b of the wall 410 along the winding axis direction of the coil portion 20. The shape of the communicating paths 412 viewed from the X-axis direction corresponds to the cross-sectional shape of the middle leg portion 32 of the core 3a or 3b and is circular in the example shown in FIG. 2.

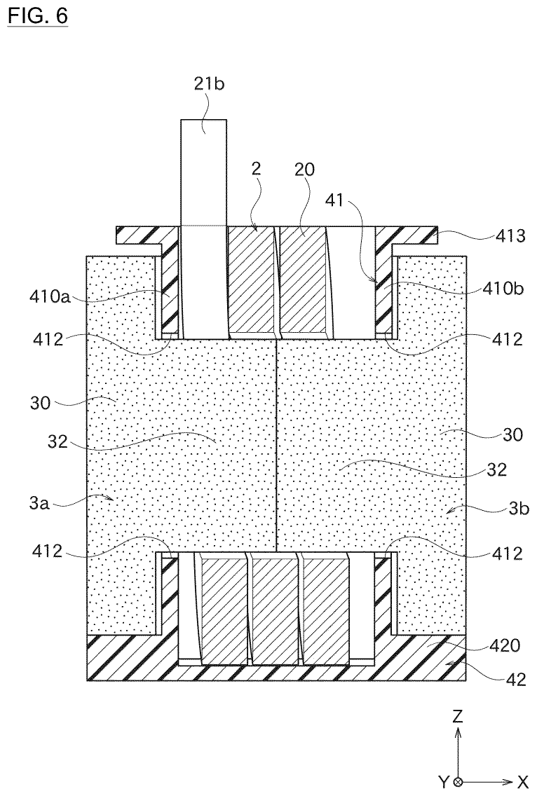

As shown in FIG. 6, through the communicating path 412 of the first portion 410a, the middle leg portion 32 of the core 3a can be housed in the housing portion 41. Likewise, through the communicating path 412 of the second portion 410b, the middle leg portion 32 of the core 3b can be housed in the housing portion 41.

With the cores 3a and 3b being attached to the case 4, the first portion 410a faces the base portion 30 of the core 3a whereas the second portion 410b faces the base portion 30 of the core 3b. As shown in FIG. 5, one outer leg portion 31 of the core 3b faces the third portion 410c whereas the other outer leg portion 31 of the core 3b faces the fourth portion 410d. Although detailed illustration is omitted, one outer leg portion 31 of the core 3a faces the third portion 410c whereas the other outer leg portion 31 of the core 3a faces the fourth portion 410d.

As shown in FIG. 4, the length L1 along the Y-axis between the third portion 410c and the fourth portion 410d is longer than the length (diameter) L2 of the coil portion 20 along the Y-axis. Thus, between the outer circumferential surface of the coil portion 20 and the third portion 410c is a space. Likewise, between the outer circumferential surface of the coil portion 20 and the fourth portion 410d is a space. The location of the coil portion 20 in the Y-axis direction is limited within a range of the space between the outer circumferential surface of the coil portion 20 and the third portion 410c or a range of the space between the outer circumferential surface of the coil portion 20 and the fourth portion 410d. Thus, with regard to the Y-axis direction, misalignment of the coil portion 20 can be prevented.

The length L1 along the Y-axis between the third portion 410c and the fourth portion 410d is longer than the maximum length between the lead-out portions 21a and 21b along the Y-axis. However, in the present embodiment, the maximum length between the lead-out portions 21a and 21b along the Y-axis is equivalent to the length (diameter) L2 of the coil portion 20 along the Y-axis. Thus, between the lead-out portion 21a and the third portion 410c is a space. Likewise, between the lead-out portion 21b and the fourth portion 410d is a space. The location of the lead-out portion 21a in the Y-axis direction is limited within a range of the space between the lead-out portion 21a and the third portion 410c. Likewise, the location of the lead-out portion 21b in the Y-axis direction is limited within a range of the space between the lead-out portion 21b and the fourth portion 410d. Thus, with regard to the Y-axis direction, misalignment of the lead-out portions 21a and 21b can be prevented. Also, functioning as stoppers, the third portion 410c and the fourth portion 410d can prevent rotation of the lead-out portions 21a and 21b.

In the present disclosure, “equivalent” is not a concept indicating only a state where the physical quantities of multiple objects for comparison are strictly equivalent to each other; and the concept of “equivalent” includes a state with a variation of ±Δ% or less (not limited; e.g., Δ=7, 5, or 3) between the physical quantities of the multiple objects for comparison.

The length L3 along the X-axis between the first portion 410a and the second portion 410b is longer than the length (thickness) LA of the coil portion 20 along the X-axis. Thus, between one end of the coil portion 20 in the winding axis direction and the first portion 410a is a space. Likewise, between the other end of the coil portion 20 in the winding axis direction and the second portion 410b is a space. The location of the coil portion 20 in the X-axis direction is limited within a range of the space between the one end of the coil portion 20 in the winding axis direction and the first portion 410a or a range of the space between the other end of the coil portion 20 in the winding axis direction and the second portion 410b. Thus, with regard to the X-axis direction, misalignment of the coil portion 20 can be prevented.

The length L3 along the X-axis between the first portion 410a and the second portion 410b is longer than the maximum length between the lead-out portions 21a and 21b along the X-axis. However, the maximum length between the lead-out portions 21a and 21b along the X-axis is equivalent to the length (thickness) LA of the coil portion 20 along the X-axis. Thus, between the lead-out portion 21a and the first portion 410a is a space. Likewise, between the lead-out portion 21b and the second portion 410b is a space. The location of the lead-out portion 21a in the X-axis direction is limited within a range of the space between the lead-out portion 21a and the first portion 410a. Likewise, the location of the lead-out portion 21b in the X-axis direction is limited within a range of the space between the lead-out portion 21b and the second portion 410b. Thus, with regard to the X-axis direction, misalignment of the lead-out portions 21a and 21b can be prevented.

As shown in FIG. 1, at least a part of the lead-out portion 21a protrudes from the housing portion 41 along the housing direction (the direction in which the coil portion 20 is housed in the housing portion 41). Likewise, at least a part of the lead-out portion 21b protrudes from the housing portion 41 along the housing direction.

As shown in FIG. 2, the flange 413 is located at the upper end of the wall 410 and protrudes outward from the wall 410 along a direction perpendicular to the axis direction of the wall 410. With the cores 3a and 3b being attached to the case 4, the flange 413 functions as a stopper restricting upward misalignment of the cores 3a and 3b.

The core supporting portion 42 is connected to one end of the housing portion 41 in the housing direction (Z-axis direction) and supports the cores 3a and 3b. The core supporting portion 42 includes or has a base 420, a base opening 421 (FIG. 3), and leg portions 422a to 422d.

The base 420 is connected to a lower end of the wall 410 and protrudes outward from the wall 410 along the direction perpendicular to the axis direction of the wall 410. The base 420 has a ring shape. An upper surface of the base 420 is a flat surface so that at least a part of the core 3a (in the example shown in FIG. 2, the base portion 30 and the outer leg portions 31) and at least a part of the core 3b (in the example shown in FIG. 2, the base portion 30 and the outer leg portions 31) can be disposed there. As shown in FIG. 1, the base 420 supports the cores 3a and 3b. The cores 3a and 3b are disposed between the flange 413 and the base 420.

As shown in FIG. 3, the base 420 has the base opening 421. Via the base opening 421, the core supporting portion 42 communicates with the housing portion 41. A part of the base opening 421 is blocked with the coil supporting portion 43.

The leg portions 422a to 422d are provided at a bottom surface of the base 420 and protrude from the base 420 in a direction (downward) away from the housing portion 41. In the example shown in FIG. 3, the number of the leg portions is four; however, the number may be two, three, or five or more. The leg portions 422a to 422d are located at four corners of the base 420 but may be located at locations other than the corners of the base 420. In the example shown in FIG. 3, the leg portions 422a to 422d each have an L shape viewed from the Z-axis direction. The leg portions 422a to 422d each extend along the periphery of the base 420 so as to be bent.

The leg portion 422b is apart from the leg portion 422a, and the leg portions 422a and 422b have a space 423 therebetween. The leg portion 422c is apart from the leg portion 422b, and the leg portions 422b and 422c have a space 423 therebetween. The leg portion 422d is apart from the leg portion 422c, and the leg portions 422c and 422d have a space 423 therebetween. The leg portion 422d is apart from the leg portion 422a, and the leg portions 422a and 422d have a space 423 therebetween. The number of the spaces 423 is four but may be two, three, or five or more. In the space 423 between the leg portions 422b and 422c, a part of the coil supporting portion 43 is disposed. Likewise, in the space 423 between the leg portions 422a and 422d, a part of the coil supporting portion 43 is disposed.

As cooling air flows to the coil device 1, at least a part of the cooling air flows from the spaces 423 to the base opening 421 and flows from the base opening 421 to the housing opening 411. Alternatively, at least a part of the cooling air flows from the housing opening 411 to the base opening 421 and flows from the base opening 421 to the spaces 423.

In the present embodiment, while the spaces 423 (or the housing opening 411) play a role as an inlet for introducing cooling air into the case 4, the housing opening 411 (or the spaces 423) plays a role as an outlet for letting the cooling air go outside the case 4. Thus, a flow path of the cooling air is provided between the spaces 423 and the housing opening 411 through the base opening 421.

The coil supporting portion 43 extends from one side to the other side of the base 420 in the X-axis direction and bridges the base opening 421 from its one side to the other side along the X-axis. However, the shape of the coil supporting portion 43 is not limited to the shape shown in FIG. 3. The coil supporting portion 43 may be a cantilever beam protruding from one side to the other side of the base 420 in the X-axis direction. Viewed from the Z-axis direction, the coil supporting portion 43 is disposed in the base opening 421. In the example shown in FIG. 3, a part of the coil supporting portion 43 is provided at the bottom surface of the base 420.

As shown in FIG. 5, the coil supporting portion 43 is partly in contact with the outer circumferential surface of the coil portion 20 and supports the outer circumferential surface of the coil portion 20. Supporting the coil portion 20, the coil supporting portion 43 has a role in controlling the height of the coil portion 20. The coil portion 20 is disposed, for example, at a height at which a center of the coil portion 20 and a center of the middle leg portion 32 match, viewed from the X-axis direction. In this situation, between an outer circumferential surface of the middle leg portion 32 and an inner circumferential surface of the coil portion 20 is a space.

The location of an upper surface of the coil supporting portion 43 (surface that is in contact with the outer circumferential surface of the coil portion 20) is lower than the location of the bottom surface of the base 420. Thus, as the coil portion 20 is disposed on the coil supporting portion 43, a part (lower part) of the coil portion 20 protrudes downward from the bottom surface of the base 420. In contrast, an upper part of the coil portion 20 does not protrude from the housing opening 411 and is inside the housing portion 41.

Now, a method of manufacturing the coil device 1 is described. First, the coil portion 20 is housed in the housing portion 41 shown in FIG. 2 to place the coil portion 20 on the coil supporting portion 43 shown in FIG. 5. The lead-out portions 21a and 21b at least partly protrude outward from the housing portion 41. Then, through the communicating paths 412 shown in FIG. 2, the middle leg portions 32 of the cores 3a and 3b are inserted in the housing portion 41. Also, the base portions 30 and the outer leg portions 31 of the cores 3a and 3b are disposed on the base 420 of the core supporting portion 42. In the above manner, the coil device 1 can be manufactured.

As shown in FIG. 1, the case 4 of the coil device 1 of the present embodiment includes the housing portion 41, where the coil portion 20 is housed along the housing direction (Z-axis direction) perpendicular to the winding axis direction of the coil portion 20. The housing portion 41 covers at least a part of the outer circumferential surface of the coil portion 20. Thus, the housing portion 41 restricts the location of the outer circumferential surface of the coil portion 20, making it easier to stabilize the location of the coil portion 20. As shown in FIG. 5, the case 4 also includes the coil supporting portion 43, which supports the outer circumferential surface of the coil portion 20. Support of the outer circumferential surface of the coil portion 20 by the coil supporting portion 43 further stabilizes the location of the coil portion 20. This can prevent misalignment of the coil portion 20.

As shown in FIGS. 2 and 5, the housing portion 41 has the communicating path 412, which is for inserting at least a part of the core 3b (the middle leg portion 32) in the housing portion 41 along the winding axis direction of the coil portion 20. This enables at least a part of the core 3b to be disposed in the coil portion 20 through the communicating path 412, improving inductance characteristics of the coil device 1.

The housing portion 41 includes the wall 410, which has the tubular shape. Moreover, the housing portion 41 has the housing opening 411, which is for housing the coil portion 20 in the housing portion 41, and the communicating path 412, which has the hole shape penetrating the wall 410 in the winding axis direction of the coil portion 20. Housing the coil portion 20 in the tubular-shaped housing portion 41 enables at least a part of the outer circumferential surface of the coil portion 20 to be covered with the housing portion 41, effectively preventing misalignment of the coil portion 20. Also, through the housing opening 411, the coil portion 20 can be easily housed in the housing portion 41. Also, through the communicating path 412, at least a part of the core 3a can be housed in the housing portion 41. This improves inductance characteristics of the coil device 1.

As shown in FIGS. 3 and 5, the core supporting portion 42 includes the base 420, which has the ring shape, with the base opening 421. The core 3b is disposed on the base 420. Viewed from the housing direction (the direction in which the coil portion 20 is housed in the housing portion 41), the coil supporting portion 43 is located in the base opening 421. With the core 3a being disposed on the base 420, misalignment of the core 3a can be prevented. Also, through the base opening 421, cooling air can flow to the coil portion 20 housed in the housing portion 41.

The core supporting portion 42 also includes the leg portions 422a and 422b, which protrude from the base 420 in the direction away from the housing portion 41. The leg portions 422a and 422b have the space 423 therebetween. Thus, as cooling air flows to the coil device 1, at least a part of the cooling air flows through the space 423 and the base opening 421 to the coil portion 20. This can increase cooling efficiency of the coil portion 20.

At least a part of the lead-out portion 21a protrudes from the housing portion 41 along the housing direction (the direction in which the coil portion 20 is housed in the housing portion 41). This reduces the mounting area of the coil device 1, enabling highly dense mounting of the coil device 1.

### Second Embodiment

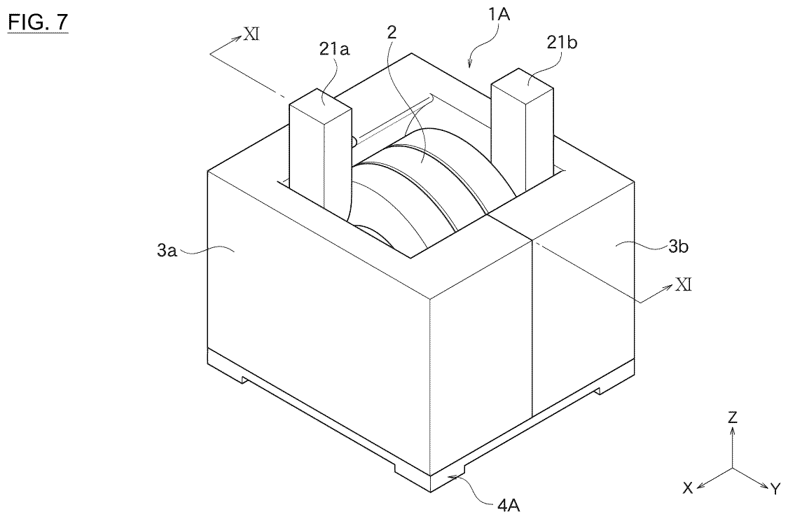

A coil device 1A of a second embodiment shown in FIG. 7 has structures similar to those of the coil device 1 of the first embodiment, except for the following. Parts of the coil device 1A common to the coil device 1 of the first embodiment are given the same reference numerals, and their detailed description is omitted.

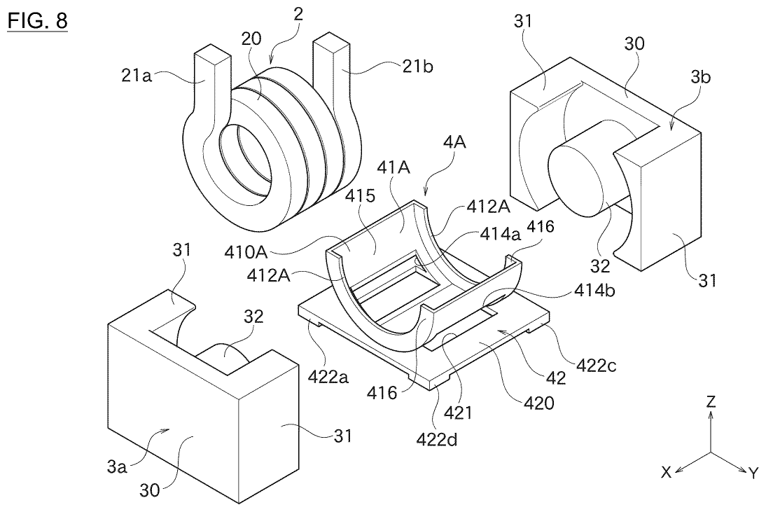

As shown in FIG. 7, the coil device 1A is different from the coil device 1 of the first embodiment in that the coil device 1A includes a case 4A. As shown in FIG. 8, the case 4A includes a housing portion 41A. The housing portion 41A includes or has a wall 410A, a communicating path 412A, and through-holes 414a to 414b.

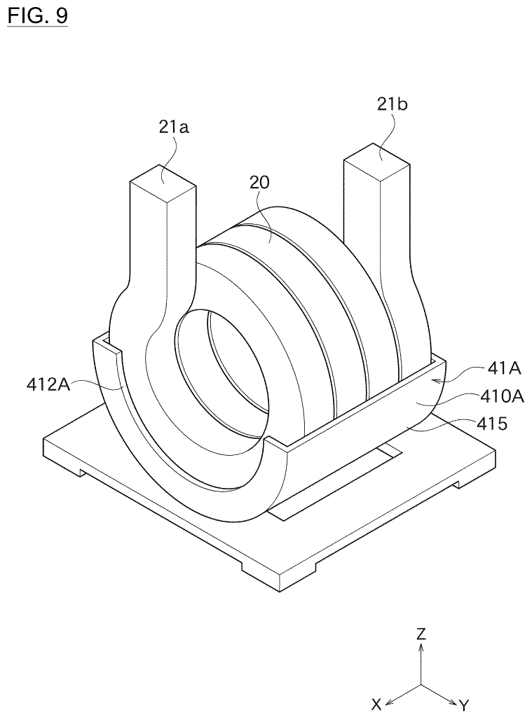

The wall 410A includes a curved portion 415 and a pair of side walls 416. The curved portion 415 is curved in an arc (a C-shape) along an outer circumferential surface of a coil portion 20. A bottom portion (lower end) of the curved portion 415 is connected to a core supporting portion 42. The side walls 416 are located at both ends of the curved portion 415 in the X-axis direction and protrude radially inward from the curved portion 415. As shown in FIG. 9, the side walls 416 restrict the location of the coil portion 20 in the X-axis direction housed in the housing portion 41A.

As shown in FIG. 8, the communicating path 412A is provided along the side walls 416 and is curved in an arc (a C shape) according to the shape of the curved portion 415. Through the communicating path 412A, a middle leg portion 32 of a core 3a is housed in the housing portion 41A along the winding axis direction of the coil portion 20. Through the communicating path 412A, a middle leg portion 32 of a core 3b is housed in the housing portion 41A along the winding axis direction of the coil portion 20.

As shown in FIG. 9, the coil portion 20 is housed in the housing portion 41A. The coil portion 20 is housed in the housing portion 41A along a housing direction (Z-axis direction). The curved portion 415 covers at least a lower part of the outer circumferential surface of the coil portion 20 housed in the housing portion 41A. In the present embodiment, the diameter of the coil portion 20 is larger than the maximum length between lead-out portions 21a and 21b along the Y-axis.

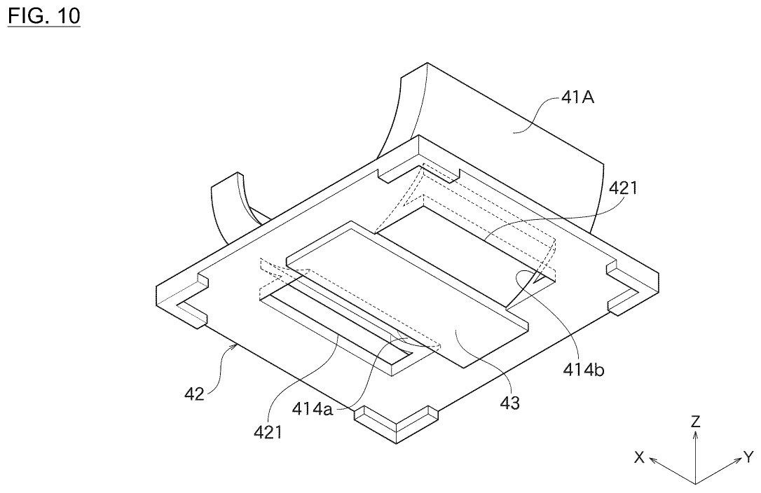

As shown in FIGS. 8 and 10, the through-holes 414a and 414b penetrate the curved portion 415. Thus, as cooling air flows to the coil device 1A, at least a part of the cooling air flows through a base opening 421 and the through-hole 414a to the inside of the housing portion 41A. Likewise, at least a part of the cooling air flows through the base opening 421 and the through-hole 414b to the inside of the housing portion 41A. This can cool at least a part of the coil portion 20 housed in the housing portion 41A.

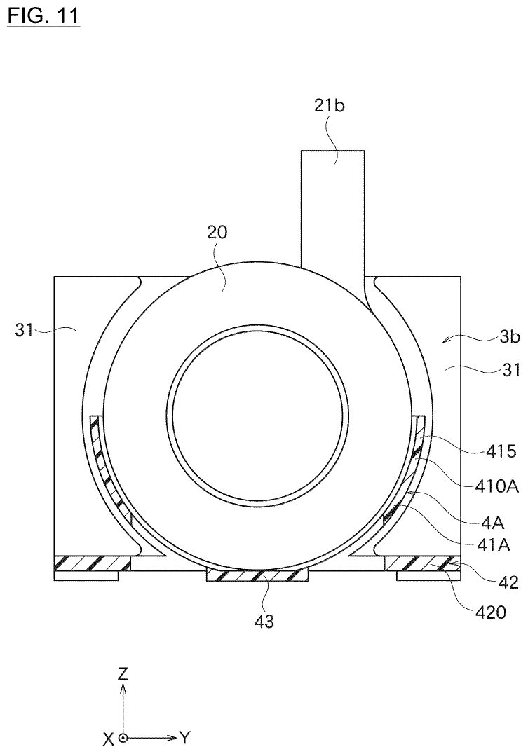

As shown in FIG. 11, between the outer circumferential surface of the coil portion 20 and the curved portion 415 is a space intermittently extending along the outer circumferential surface of the coil portion 20 and/or the curved portion 415. The location of the coil portion 20 is limited within a range of the space between the outer circumferential surface of the coil portion 20 and the curved portion 415. This enables positioning of the coil portion 20 in the Y-axis direction. Note that the space between the outer circumferential surface of the coil portion 20 and the curved portion 415 is discontinuous where the coil portion 20 and a coil supporting portion 43 come into contact.

In the example shown in FIG. 11, inner circumferential surfaces of outer leg portions 31 of the core 3b are curved in an arc (a C-shape) along the outer circumferential surface of the coil portion 20, viewed from the X-axis direction. Although detailed illustration is omitted, inner circumferential surfaces of outer leg portions 31 of the core 3a are curved along the outer circumferential surface of the coil portion 20, viewed from the X-axis direction.

With the coil portion 20 being housed in the housing portion 41A, between the lead-out portion 21b and an upper end portion of the corresponding outer leg portion 31 of the core 3b is a space. Functioning as a stopper, the upper end portion of the outer leg portion 31 of the core 3b can prevent rotation of the lead-out portion 21b. Although detailed illustration is omitted, between the lead-out portion 21a and an upper end portion of the corresponding outer leg portion 31 of the core 3a is a space. Functioning as a stopper, the upper end portion of the outer leg portion 31 of the core 3a can prevent rotation of the lead-out portion 21a.

As shown in FIG. 8, in the present embodiment, the housing portion 41A includes the wall 410A, which is curved along the outer circumferential surface of the coil portion 20. The housing portion 41A has the through-hole 414a, which penetrates the wall 410A. Thus, as cooling air flows to the coil device 1A, at least a part of the cooling air flows through the through-hole 414a to the inside of the housing portion 41A. This enables the cooling air to hit at least a part of the coil portion 20, increasing cooling efficiency of the coil portion 20.

The present disclosure is not limited to the above embodiments and can be variously modified within the scope of the present disclosure.

As shown in FIG. 1, in the above embodiments, the number of the wire 2 (coil portion 20) is one; however, the number may be plural (e.g., two). In this situation, the coil device 1 can function as, for example, a transformer.

### REFERENCE NUMERALS

1, 1A . . . coil device
2 . . . wire
20 . . . coil portion
21a, 21b . . . lead-out portion
3a, 3b . . . core
30 . . . base portion
31 . . . outer leg portion
32 . . . middle leg portion
4, 4A . . . case
41, 41A . . . housing portion
410, 410A . . . wall
410a to 410d . . . first portion to fourth portion
411 . . . housing opening
412, 412A . . . communicating path
413 . . . flange
414a, 414b . . . through-hole
415 . . . curved portion
416 . . . side wall
42 . . . core supporting portion
420 . . . base
421 . . . base opening
422a to 422d . . . leg portion
423 . . . space
43 . . . coil supporting portion

What is claimed is:

1. A coil device comprising:
a flat wire including a coil portion and a lead-out portion drawn out from the coil portion;
a core disposed around the coil portion; and
a case including
a housing portion housing the coil portion along a housing direction perpendicular to a winding axis direction of the coil portion,
a core supporting portion connected to one end of the housing portion in the housing direction and supporting the core, and
a coil supporting portion supporting an outer circumferential surface of the coil portion,
wherein the housing portion covers at least a part of the outer circumferential surface of the coil portion.

2. The coil device according to claim 1, wherein the housing portion has a communicating path for inserting at least a part of the core in the housing portion along the winding axis direction.

3. The coil device according to claim 2, wherein
the housing portion includes a wall having a tubular shape; and
the housing portion has
a housing opening for housing the coil portion in the housing portion, and
the communicating path having a hole shape penetrating the wall in the winding axis direction.

4. The coil device according to claim 1, wherein
the core supporting portion includes a base having a ring shape with a base opening;
the core is disposed on the base; and
at least a part of the coil supporting portion is located in the base opening viewed from the housing direction.

5. The coil device according to claim 1, wherein
the core supporting portion includes a base having a ring shape with a base opening;
the core supporting portion includes leg portions protruding from the base in a direction away from the housing portion; and
the leg portions have a space therebetween.

6. The coil device according to claim 1, wherein at least a part of the lead-out portion protrudes from the housing portion along the housing direction.

7. The coil device according to claim 1, wherein
the housing portion includes a wall curved along the outer circumferential surface of the coil portion; and
the housing portion has a through-hole penetrating the wall.
